(19) United States
(12) Patent Application Publication
(10) Pub. No.: US 2004/0196381 A1
(43) Pub. Date: Oct. 7, 2004

(54) Image processing method and apparatus

(75) Inventor: Chiaki Matsuzaka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/806,196

(22) Filed: Mar. 23, 2004

(30) Foreign Application Priority Data
Apr. 1, 2003 (JP) 2003-098043

(51) Int. Cl. H04N 5/228

(52) U.S. Cl. 348/222.1

(57) ABSTRACT

When image data in a common format is generated from an image file including RAW image data obtained by digitizing signals output from an imaging device, the RAW image data being either uncompressed or lossless-compressed, a processing module to be used is selected from a plurality of types of processing modules based on image property information associated with the RAW image. Using the selected processing module, the RAW image data is converted into image data in an intermediate format that is different from the common format. Then, image data in the common format is generated based on the image data in the intermediate format.

### BACKGROUND OF THE INVENTION

1. Field of the Invention

The present invention relates to image processing techniques. More specifically, the present invention relates to image processing techniques for reading and playing back, developing, or processing image information input from an optical sensor such as a CCD or CMOS sensor of a digital still camera or digital video camera and recorded on a medium.

2. Description of the Related Art

Techniques for using digital image information captured by a digital still camera or digital video camera and output from an image sensor without executing image processing relating to the colors of the image such as adjustment of white balance have been known. (Hereinafter, such digital image information that has not substantially been processed will be referred to as RAW image data.) For example, in the case of a RAW image obtained by A/D conversion of signals output from an imaging device without compressing it, a playback or development process is always executed based on the RAW image. Thus, for example, sophisticated image processing can be executed based on parameters arbitrarily set by a user using an image processing unit external or internal to the imaging device. Accordingly, image data including luminance signals and color signals is played back or developed, serving to achieve a higher quality. Furthermore, depending on the preference of the user, image data for playback or development that are not affected by degradation of image quality of image processing can be generated as many times as desired.

When a RAW image is processed and/or played back by an image processing apparatus, image processing such as interpolation of pixels, adjustment of white balance, adjustment of luminance, adjustment of colors, and adjustment of sharpness are executed before playback, based on property information recorded in association with the RAW image or characteristics of main image information. For example, the image is expanded in accordance with the compression format, color interpolation of pixels and adjustment of white balance are executed based on the property of the main image information and information regarding a light source used for imaging, and adjustment of luminance, adjustment of colors, and adjustment of sharpness are executed based on exposure time, shutter speed, zoom position, and other related parameters.

Furthermore, when image processing such as color adjustment is executed on image information that has been played back, image processing and/or playback is executed based on property information and user-defined information. The color filter characteristics refer to characteristics including at least one of pixel arrangement, arrangement of color filters, sensitivity of pixels (e.g., dispersion characteristics).

However, property information of RAW images, needed for image processing and/or playback, varies depending on manufacturers and device types. Furthermore, due to difference in color filter characteristics (color filter arrangement, distinction between complementary color filters and primary color filters, distinction between a sensor including multi-color photosensitive-layers having color separation characteristics with respect to the depth direction and a sensor including monochrome photosensitive-layers, bit depth, aspect ratio of pixels) of CCDs and difference in compression formats, different image processing methods, and therefore different image processing apparatuses, must be used depending on characteristics of RAW images specific to different camera types. The bit depth refers to the number of bits used to represent the tone corresponding to an image signal from the CCD or the number of colors. The aspect ratio of pixels is the ratio of the vertical side to the horizontal side of a rectangular array of pixels.

Thus, in order to allow operations on such RAW image files by a common image processing apparatus, image data are converted into a common format, such as bitmap format or JPEG format and then saved.

However, when image data that has been converted into a common image data format is used, the following problems arise.

(1) Even when the dynamic range of an optical sensor is wider and the bit depth is deeper accordingly, image data must be converted into a common image format in order to allow image processing and/or playback by a common image processing apparatus. This could cause degradation in image quality due to limitation in the bit depth, attributable to conversion into the common image format.

(2) When lossy compression is applied during the conversion into the common image data format, the image data is degraded even further.

(3) Information representing the status of the imaging device used for image processing (e.g., ISO sensitivity and exposure time) could be lost or erased during conversion into the common image data format.

(4) Even if the problem (3) is overcome, that is, even if the information representing the status of the imaging device used for image processing (e.g., ISO sensitivity and exposure time) is recorded in association with main image information during conversion into the common image data format, it is often the case that the information is not used or parsed for image processing by the image processing apparatus.

On the other hand, when a plurality of types of image processing apparatuses are used to use RAW images, the following problems arise.

(1) The formats of RAW images vary depending on manufacturers or types of imaging devices. Thus, it is laborious for the user to use different image processing apparatuses depending on RAW images.

(2) When an algorithm more favorable than a currently available algorithm has been developed, if different image processing apparatuses are used depending on device types, developers must alter a substantial amount of code, causing an increase in development cost.

(3) When an algorithm more favorable than a currently available algorithm has been developed, a user is not allowed to adjust image quality of or playback a RAW image captured by an imaging device of a manufacturer that does not employ the favorable algorithm.

### SUMMARY OF THE INVENTION

The present invention has been made in view of the problems described above, and it is an object of the present invention to provide image data having unified data formats of property information and main image information while maintaining advantages of RAW images, allowing unification of image processing for converting, for example, RAW image files into files in common formats.

In order to achieve the object described above, the present invention, in one aspect thereof, provides an image processing method for generating image data in a second format from image data in a first format, the image data in the first format including image data that is uncompressed or compressed and substantially losslessly, obtained by digitizing signals output from an imaging device, and the image data in the second format including a luminance signal and color signals, the image processing method including selecting a processing module to be used from among a plurality of types of processing modules, based on image property information associated with the image data in the first format; converting the image data in the first format into image data in a third format that is different from the second format, using the processing module selected in the selecting; and generating the image data in the second format based on the image data in the third format.

The present invention, in another aspect thereof, provides an image processing apparatus for generating image data in a second format from image data in a first format, the image data in the first format including image data that is uncompressed or compressed and substantially losslessly, obtained by digitizing signals output from an imaging device, and the image data in the second format including a luminance signal and color signals, the image processing apparatus including a selecting unit which selects a processing module to be used from among a plurality of types of processing modules, based on image property information associated with the image data in the first format; a converting unit which converts the image data in the first format into image data in a third format that is different from the second format, using the processing module selected by the selecting unit; and a generating unit which generates the image data in the second format based on the image data in the third format.

The present invention, in another aspect thereof, provides a storage medium storing a control program for allowing a computer to execute image processing for generating image data in a second format from image data in a first format, the image data in the first format including image data that is uncompressed or compressed and substantially losslessly, obtained by digitizing signals output from an imaging device, and the image data in the second format including a luminance signal and color signals, wherein a processing module to be used is selected from among a plurality of types of processing modules, based on image property information associated with the image data in the first format, the image data in the first format is converted into image data in a third format that is different from the second format, using the processing module selected, and the image data in the second format is generated based on the image data in the third format.

The present invention, in another aspect thereof, provides a control program for allowing a computer to execute image processing for generating image data in a second format from image data in a first format, the image data in the first format including image data that is uncompressed or compressed and substantially losslessly, obtained by digitizing signals output from an imaging device, and the image data in the second format including a luminance signal and color signals, wherein a processing module to be used is selected from among a plurality of types of processing modules, based on image property information associated with the image data in the first format, the image data in the first format is converted into image data in a third format that is different from the second format, using the processing module selected, and the image data in the second format is generated based on the image data in the third format.

Further objects, features and advantages of the present invention will become apparent from the following description of the preferred embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of a digital still camera that serves as an image input device.

FIG. 2 is a flowchart showing a process for recording an image by an image input device.

FIG. 3 is a schematic diagram of an image file.

FIGS. 4A and 4B are diagrams showing a pixel arrangement of image signals.

FIG. 5 is a schematic diagram showing how color signals are input by a photoelectric converter including multi-color photosensitive layers.

FIGS. 6A and 6B are schematic diagrams showing image signals input from a photoelectric converter whose aspect ratio of pixels is not 1:1.

FIG. 7A is a flowchart showing a process of displaying and outputting a RAW image.

FIG. 7B is a flowchart showing a process of displaying and outputting a RAW image.

FIG. 8 is a block diagram showing the configuration of an information processing apparatus for executing image processing according to an embodiment of the present invention.

FIG. 9 is a block diagram showing the functional configuration of image processing according to the embodiment.

### DESCRIPTION OF THE PREFERRED EMBODIMENTS

Now, a preferred embodiment of the present invention will be described with reference to the accompanying drawings. The embodiment will be described, as an example, in the context of an electronic camera such as a digital still camera.

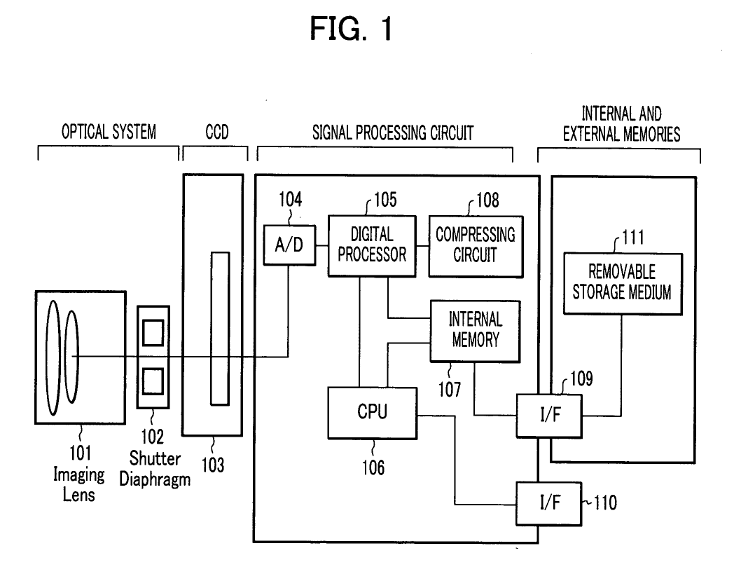

FIG. 1 is a block diagram showing the configuration of a digital still camera that serves as an image input device in this embodiment. Referring to FIG. 1, an imaging optical system is formed by an imaging lens 101, a shutter diaphragm 102, and other related parts. A photoelectric converter (hereinafter referred to as a CCD) 103 converts optical signals of a target, focused by the imaging optical system (101 and 102), into electric signals.

An analog-digital converter 104 converts an output of the CCD 103 (an analog signal) into a digital signal. A digital processor 105 processes signals digitized by the analog-digital converter 104. A CPU 106 executes various camera-control operations and signal processing. An internal memory 107 includes a read-only memory and a random access memory. The read-only memory stores control programs. The random access memory is used as a temporary storage memory during processing by the CPU 106. A compressing circuit 108 compresses digital signals to be recorded. An interface 109 allows connection with a removable storage medium. An interface 110 allows connection with a personal computer or the like. The analog-digital converter 104 to the interface 110 and other related parts constitute a signal processing circuit of the digital still camera according to this embodiment. A storage medium 111 is a removable storage medium that is removable from the digital still camera.

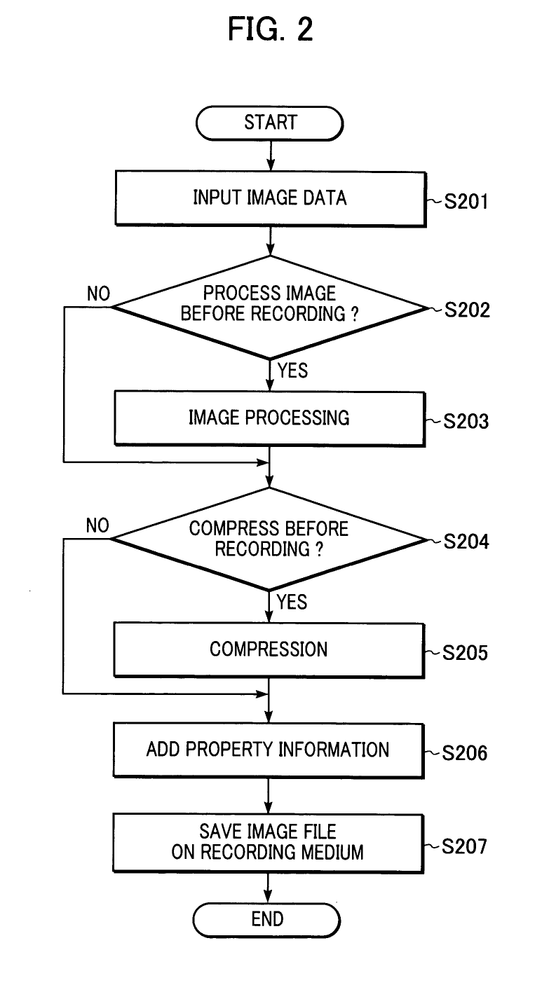

FIG. 2 is a flowchart showing image data processing by the digital still camera according to this embodiment. This process is executed by the CPU 106 executing a control program stored in the internal memory 107.

In step S201, image data is input to the memory. In this embodiment, optical signals are converted into electric signals by the CCD 103, the electric signals are digitized by the analog-digital converter 104, and the resulting digital signal serves as the image data. In step S202, it is determined whether the image data is to be processed before recorded in a common image data format (e.g., JPEG). More specifically, in this embodiment, it is determined whether a person who captured the image selected, at the time of imaging, a mode in which data output from the CCD 103 is recorded without being processed (RAW image output mode). If the RAW image output mode was selected, the procedure proceeds to step S204, and otherwise the procedure proceeds to step S203.

In step S203, image processing is executed. In this embodiment, filtering, color adjustment based on information such as white balance and auto focus, and the like, are executed. Then, in step S204, it is determined whether the image data is to be compressed before being recorded. More specifically, in this embodiment, it is determined whether the person who captured the image selected a compressed recording mode at the time of imaging. The procedure proceeds to step S205 if the compressed recording mode was selected, and the image is compressed by the compressing circuit 108. The compression method is either lossless or lossy. In step S206, property information is attached to the image data. In this embodiment, the property information include information such as imaging date/time, type of camera, whether flash is on or off, recording format, and other imaging conditions. In step S207, the image data is recorded on the removable recording medium 111. In this embodiment, the removable storage medium 111 is, for example, a CompactFlash® card.

In this embodiment, image processing is not executed in step S202, and image information recorded without being compressed in step S206 or image information lossless-compressed and recorded in step S205, i.e., RAW image, is processed.

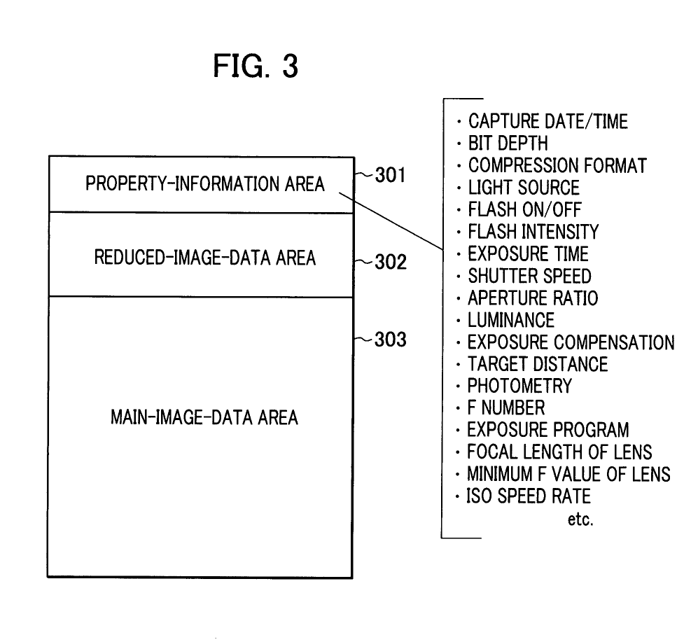

FIG. 3 is schematic diagram of an image file that is created by an image recording method in this embodiment. Referring to FIG. 3, a property-information area 301 is an area where information representing imaging parameters and other related information needed for reading, playing back, or selecting an image, such as image data size, imaging date/time, type of camera, compression method, and whether flash is on or off, are stored. Furthermore, as information to be used for photoelectric conversion of an optical image, for example, information regarding the optical system for forming the optical image, such as exposure time, aperture ratio, color temperature of a light source irradiating the target, characteristics of the photoelectric converter element, ISO sensitivity, and focal distance of the lens, may be included. A reduced-image-data area 302 is an area where reduced image data that is shown when a list is displayed is stored. A main-image-data area 303 is an area where all the image data to be stored in the image file is stored. When the RAW image output mode is selected, RAW image data or lossless-compressed RAW image data is stored in the main-image-data area 303.

The data structure of the RAW image described above varies depending on the hardware configuration and other device-specific factors. According to the image processing apparatus of this embodiment, when an image data file including such RAW image data is converted into an image data file in a common format, the image data including RAW image data is first converted into image data in an intermediate format. The image data in the intermediate format has a unified data format that does not depend on machine type, while maintaining the advantages of RAW image. Now, an example of variation of RAW images and conversion into a unified format will be described.

1. Main Part of Image Information

1-1. Absorption of Variation in Characteristics of Imaging Devices

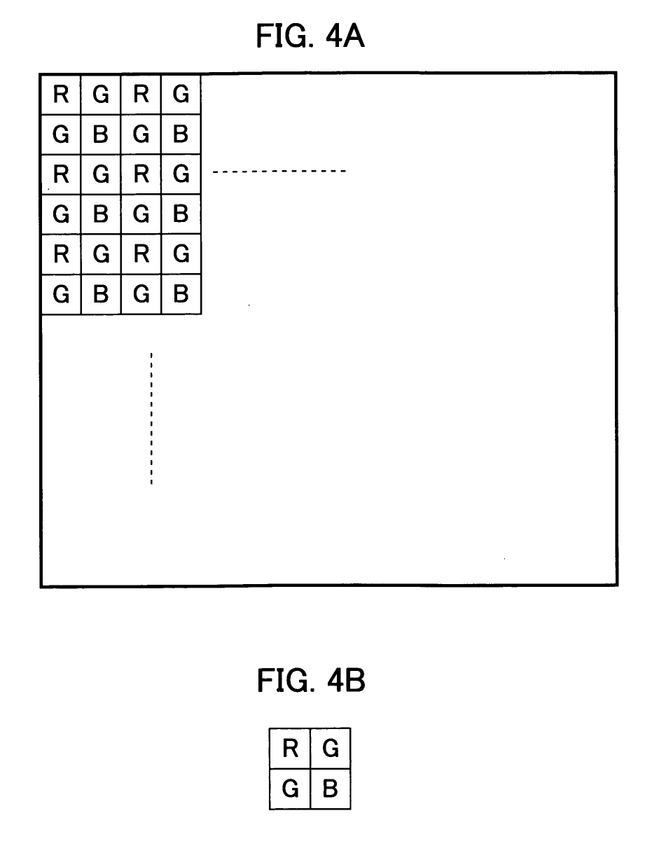

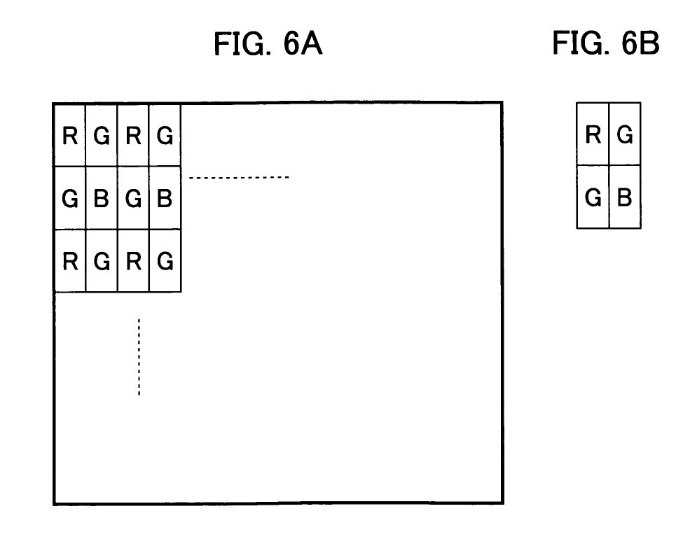

FIGS. 4A and 4B are diagram showing an example of pixel array of image signals. Data that has been digitized by the analog-digital converter 104 and then saved, in a case where primary-color filters and monochrome photosensitive layers are used in the camera, is divided into blocks as shown in FIG. 4A. Each of the blocks is composed of four pixels including color signals of red, green, and blue (RGB), as shown in FIG. 4B. In the case of complementary filters, each of the blocks is composed of color signals for cyan, magenta, and yellow (CMY). In that case, the arrangement of the pixels varies depending on the characteristics of CCD color filters. Furthermore, the pixels do not necessarily have an aspect ratio of 1:1 (e.g., 2:1), as shown in FIG. 6A. Furthermore, the bit depth of pixels constituting an image could vary depending on the characteristics of CCD color filters.

As described above, the recording conditions of RAW image stored in the main-image-data area 303 could vary depending on device type. An example of such a case and an example of conversion will be described below.

1-2. Unification of Bit Depth

If the bit depth of pixels constituting an image differs from a bit depth for executing common image processing, which can be arbitrarily chosen, the former bit depth must be matched with the latter bit depth. For example, when the bit depth of pixels constituting an image is 8 bits and the bit depth for executing common image processing is 12 bits, the conversion is done by left-shifting all the pixel values by four bits.

ColR_{—}12bit=(ColR_{—}8bit)<<(12−8)

ColB_{—}12bit=(ColB_{—}8bit)<<(12−8)

ColG_{—}12bit=(ColG_{—}8bit)<<(12−8) (1)

Generally, when a particular bit depth x (bits) is converted into a bit depth a (bits) for executing common image processing, a being larger than x, conversion is possible by left shifting by (a-x) (bits).

1-3. Conversion of Data in Accordance with Characteristics of Color Filters

In this embodiment, the format of RAW images composed of RGB values of respective pixels is unified. Thus, in a case where CCD color filters are primary color filters and monochrome photosensitive layers are used (e.g., the case shown in FIGS. 4A and 4B), an interpolation process that will be described later is performed on RAW image data obtained, whereby image data in an intermediate format for executing common image processing is obtained.

On the other hand, if the CCD color filters are complementary color filters, image information that is input is interpolated to calculate CMY values of respective pixels. Cyan, magenta, and yellow (CMY) color signals for the pixels constituting the image are converted into red, green, and blue (RGB) color signals for executing common image processing, i.e., image data in an intermediate format. In this case, the conversion is done using the following equations.

R=(Y+M−C)/2

G=(C+M−Y)/2

B=(C+Y−M)/2 (2)

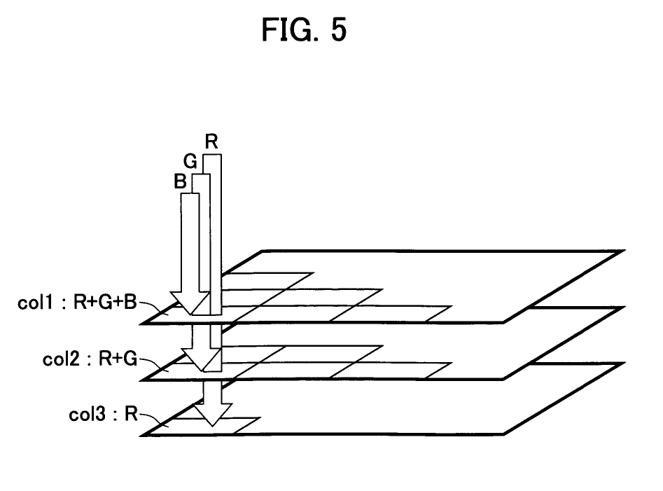

Furthermore, as shown in FIG. 5, in the case of a RAW image obtained by a CCD including multi-color photosensitive layers, a conversion process described below is executed. FIG. 5 is a schematic diagram showing how color signals are input through multi-color photosensitive layers. In the case of the multi-color photosensitive layers shown in FIG. 5, a single pixel does not correspond to a single color signal, but a first layer represents a value (R+G+B) obtained by adding up red, green, and blue color signals, a second layer represents a value (R+G) obtained by adding up red and green color signals, and a third layer represents a value (R) for red color signal. Let the color signal of the first layer be denoted as col1, the color signal of the second layer as col2, and the color signal of the third layer as col3. Then, the following equations are used to convert the color signals col1, col2, and col3 into red, green, and blue (RGB) color signals for executing common image processing, i.e., image data in an intermediate format.

R=col3

G=col2−col3

B=col1−col2 (3)

For example, in the case of an imaging device having a color filter arrangement similar to what is called a Beyar arrangement, shown in FIGS. 4A and 4B, in a RAW image obtained by a primary-color CCD, information of all colors does not exist in all the pixels. In order to generate (interpolate) red, blue, and green color signals (colR(x,y), colG(x,y), colB(x,y)) that do not originally exist, for example, the following equations are used.

colR(x,y)=(colR(x,y−1)+(colR(x,y+1))/2

colG(x,y)=(colG(x,y−1)+(colG(x,y+1))/2

colB(x,y)=(colB(x,y−1)+(colB(x,y+1))/2 (4)

Furthermore, if the intervals of pixels in the horizontal direction and the vertical direction (aspect ratio) are not the same (i.e., the pixels do not form a square array (refer to FIGS. 6A and 6B)) because of the arrangement of a reading circuit of the imaging device, an interpolation process is performed so that the array of the CCD pixels forms a square array.

For example, if the ratio of the pixel interval in the horizontal direction (the interval between center points of sampling) to the ratio of the pixel interval in the vertical direction is 1:2 (i.e., the pixel interval in the horizontal direction is half the pixel interval in the vertical direction), for example, considering in terms of luminance signals, output signals of the imaging device are converted so as to represent a square array, for example, by the following calculation. In the example described below, pixels of a RAW image of three rows×three columns are converted into pixels of six rows×twelve columns to generate image data representing a square array.

For example, with regard to the horizontal direction, the following equations are used to generate data of six pixels out(x−2,y), out(x−1,y), out(x,y), out(x+1,y), out(x+2,y), out(x+3,y) from data of three pixels in(x−1,y), in(x,y), in(x+1,y).

out(x−2,y)=(4*in(x−1,y))/4

out(x−1,y)=(3*in(x−1,y)+1*in(x,y))/4

out(x,y)=(1*in(x−1,y)+3*in(x,y))/4

out(x+1,y)=(1*in(x+1,y)+3*in(x,y))/4

out(x+2,y)=(3*in(x+1,y)+1*in(x,y))/4

out(x+3,y)=(4*in(x+1,y))/4 (5)

With regard to the vertical direction, for example, the following equations are used to generate data of 12 pixels out(x,y−5), out(x,y−4), out(x,y−3), out(x,y−2), out(x,y−1), out(x,y), out(x,y+1), out(x,y+2), out(x,y+3), out(x,y+4), out(x,y+5), out(x,y+6) from data of three pixels in(x,y−1), in(x,y), in(x,y+1).

out(x,y−5)=(16*in(x,y−1))/16

out(x,y−4)=(16*in(x,y−1))/16

out(x,y−3)=(15*in(x,y−1)+1*in(x,y))/16

out(x,y−2)=(11*in(x,y−1)+5*in(x,y))/16

out(x,y−1)=(5*in(x,y−1)+11*in(x,y))/16

out(x,y)=(1*in(x,y−1)+15*in(x,y))/16

out(x,y+1)=(1*in(x,y+1)+15*in(x,y))/16

out(x,y+2)=(5*in(x,y+1)+11*in(x,y))/16

out(x,y+3)=(11*in(x,y+1)+5*in(x,y))/16

out(x,y+4)=(15*in(x,y+1)+1*in(x,y))/16

out(x,y+5)=(16*in(x,y+1))/16

out(x,y+6)=(16*in(x,y+1))/16 (6)

As described above, the pixels of the RAW images having three rows×three columns, shown in FIGS. 6A and 6B, are converted into pixels of six rows×twelve columns, whereby image data representing a square array is generated. That is, the aspect ratio is corrected.

2. Unification of the Format of Property Information

Of property information that can be used in image processing of RAW images, examples of information that could differ depending on notation (units or the like) and examples of conversion of such information will be described below. In the examples described below, the formats of property information are unified by converting various property values into APEX units.

Shutter Speed: Second→APEX

Shutter speed is converted from a second to an APEX unit of shutter speed so that common image processing is allowed, using the following equation.

ShutterSpeedValue:Tv=−log2(Second) (7)

Aperture Value: F-Number→APEX

Aperture ratio is converted from a F-Number to an APEX unit of aperture value so that common image processing is allowed, using the following equation.

ApertureValue:Av=2log2(F−Number) (8)

Brightness Value: B/NK→APEX

Brightness value is converted from a B/NK to an APEX unit of brightness value so that common image processing is allowed, using the following equation.

BrightnessValue:Bv=log2(B/NK) (9)

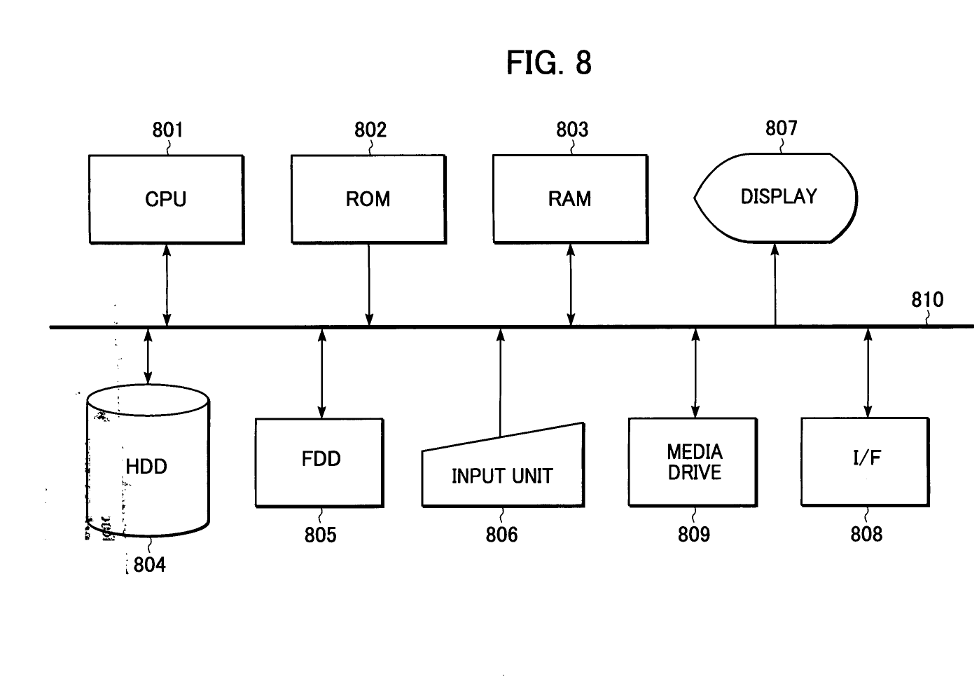

An image processing apparatus according to this embodiment for allowing the processing described above will be described. FIG. 8 shows an information processing apparatus according to this embodiment, which allows image processing described below by executing a predetermined control program, functioning as an image processing apparatus.

Referring to FIG. 8, a CPU 801 is responsible for the overall control of the apparatus. A ROM 802 stores procedures of operation of the CPU 801 (e.g., a program for booting the computer, a program for basic input/output, and the like). A RAM 803 functions as a main memory for the CPU 802. Various programs, including a control program for allowing image processing described later, are loaded from a hard disk drive 804 or the like to the RAM 803, and are executed by the CPU 801. The RAM 803 functions as a work area when the CPU 801 executes various processes.

A hard disk drive (HDD) 804 and a flexible disk drive (FDD) 805 are used to save and read application programs, data, and libraries. Alternatively or in addition to the FDD, an optical or magneto-optical disk drive for CD-ROM, MO, DVD, or the like, or a magnetic tape drive such as a tape streamer or a DDS may be provided.

An input device 806 includes, for example, a keyboard and a pointing device. A display 807 displays various information under the control of the CPU 801.

An interface 808 allows image data to be received from the interface 110 of the digital still camera shown in FIG. 1. The interfaces 808 and 110 are typically USB interfaces. A storage medium mounting unit (media drive) 809 allows the storage medium 111 detached from the digital still camera shown in FIG. 1 to be mounted thereon so that data stored in the storage medium 111 can be read. System bus 810 (including an address bus, a data bus, and a control bus) connect the units described above with each other.

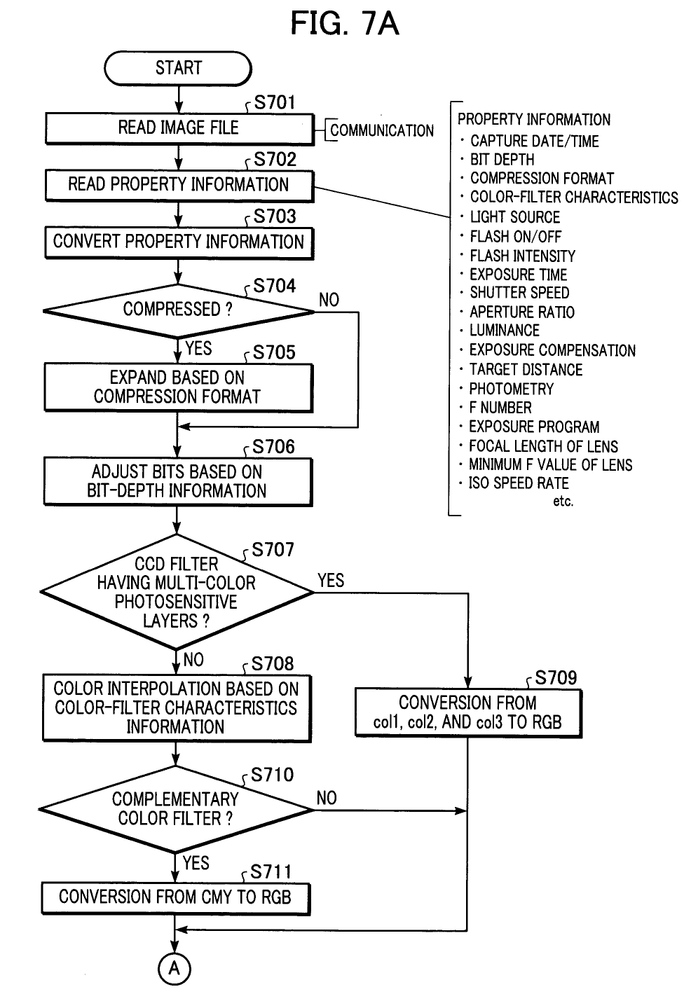

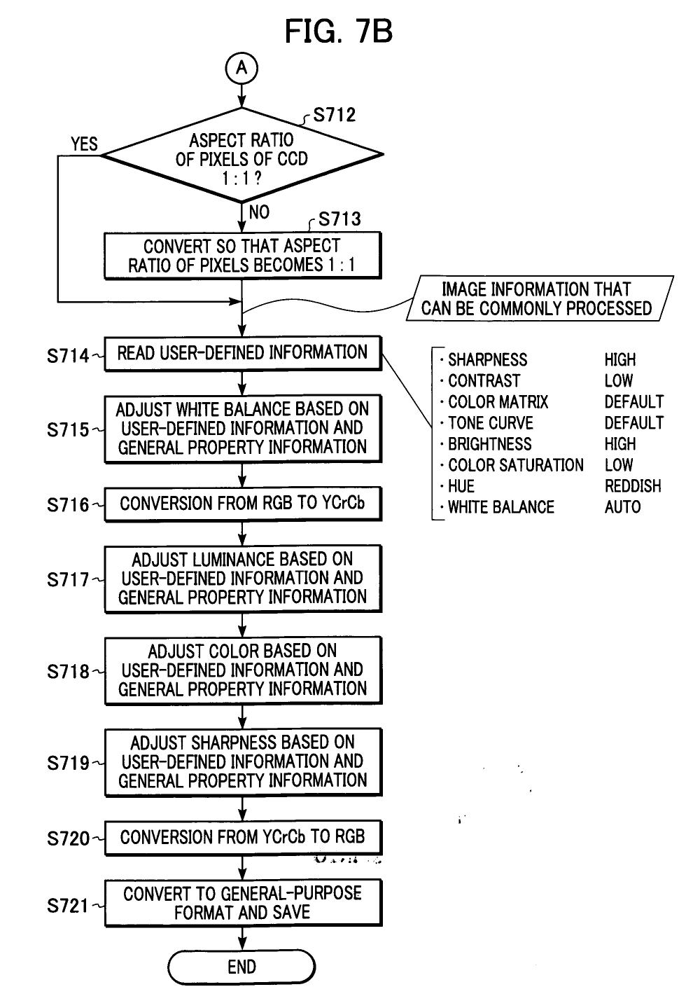

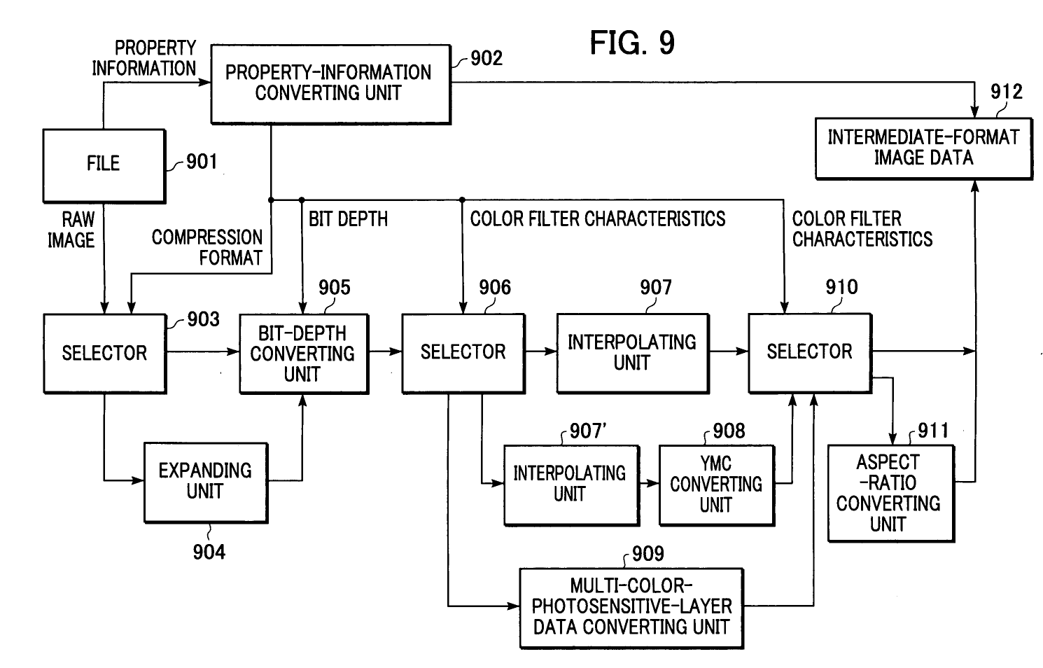

Image processing in this embodiment by the information processing apparatus configured as described above will be described in detail with reference to FIGS. 7A, 7B, and 9.

FIGS. 7A and 7B are flowcharts showing processes in which a RAW image is read from a recording apparatus and is displayed on an output apparatus (or data is output to a storage medium or the like, or a visual image is output onto a recording medium) in this embodiment. FIG. 9 is a diagram showing functional blocks for allowing conversion into image data in an intermediate format in this embodiment.

In step S701, a RAW image file is read from a recording medium. The recording medium is, for example, the hard disk 804 of the personal computer, or the storage medium 111. Alternatively, a RAW image may be read via a network that is not shown.

In step S702, property information recorded in the property-information area 301 of the RAW image file is read. The property information includes, for example, bit depth, color filter characteristics of the CCD color filters, compression format, exposure time, shutter speed, aperture value, brightness value, exposure compensation factor, minimum F value of the lens, target distance, photometry, light source, flash on/off, focal length of the lens, F number, exposure program, ISP speed rate, and flash intensity.

In step S703, a property-information converting unit 902 converts property information expressed in different notations (units or the like) into common formats (APEX units in this embodiment) according to the equations described earlier. (Hereinafter, property information having been converted into the common formats will be referred to as general property information.) For example, shutter speed is converted according to equations (7), aperture value is converted according to equations (8), and brightness value is converted according to equations (9).

In step S704, it is determined whether the RAW image data in the main-image-data area 303 is compressed. If the RAW image data is compressed, the RAW image data is expanded in step S705 based on the compression format included in the general property information. More specifically, a selector 903 forwards the RAW image to an expanding unit 904 in accordance with the compression format, where the RAW image is expanded. Although only one expanding unit is shown in FIG. 9, a plurality of types of expanding units is provided in accordance with a plurality of types of compression formats, and one of the expanding units is selected by the selector 903. If the RAW image is not compressed, the RAW image is provided as it is from the selector 903 to a bit-depth converting unit 905.

In step S706, the bit-depth converting unit 905 adjusts the bit depth of the RAW image based on the bit-depth information included in the general property information. The bit depth is adjusted according to equations (1).

In step S707, it is determined whether the imaging device has color separation characteristics with respect to the depth direction based on the color filter characteristics included in the general property information. If the imaging device does not have color separation characteristics with respect to the depth direction (i.e., in the case of monochrome photosensitive layers), color interpolation is performed in step S708. Since the RAW image is composed of the blocks shown in FIGS. 4A and 4B, a color signal representing only one color is assigned to each pixel. Thus, color interpolation is performed. For example, for the purpose of color interpolation, linear interpolation according to equations (4) described earlier is used. This is a process executed in a case where an interpolating unit 907 is selected by a selector 906 shown in FIG. 9.

On the other hand, if the color filters have color separation characteristics with respect to the depth direction in FIG. 5, color signals col1, col2, and col3 are converted into red, green, and blue (RGB) color signals in step S709. An example of conversion from the color signals col1, col2, and col3 into the red, green, and blue (RGB) color signals is expressed in equations (3). This process is executed when the selector 906 selects a multi-color photosensitive-layer data converting unit 909.

Furthermore, in the case of monochrome photosensitive layers, after color interpolation is finished (steps S707 and S708), it is determined in step S710 whether the color filters are complementary filters based on the color filter characteristics included in the general property information. If it is determined that the color filters are complementary filters, in step S711, cyan, magenta, and yellow (CMY) color signals are converted into red, green, and blue (RGB) color signals. An example of conversion from cyan, magenta, and yellow (CMY) color signals into red, green, and blue (RGB) color signals is expressed in equations (2). This corresponds to a process executed when the selector 906 selects an interpolating unit 907′ and a YMC converting unit 908. The interpolating unit 907′ executes the same interpolating process (expressed in equations (4)) as the interpolating unit 907.

Furthermore, in step S712, it is determined whether the aspect ratio of the pixels of the CCD is 1:1. If it is determined that the aspect ratio of the pixels of the CCD is not 1:1, conversion is executed in step S713 so that the aspect ratio will be 1:1. An example of conversion for achieving an aspect ratio of 1:1 is expressed in equations (5) and (6). This process is executed by a selector 910 and an aspect-ratio converting unit 911 shown in FIG. 9.

As described above, RAW image data obtained by digitizing signals output from the imaging device, either uncompressed or lossless-compressed, is converted into image data in an intermediate format that is different from a common format, using a processing module selected from a plurality of types of processing modules based on image property information associated with the RAW image data. By this process, image information that allows common image processing (image data 912 in the intermediate format) while maintaining the advantages of RAW image data is obtained. Thus, processing in steps S714 to S721 described below does not depend on manufacturers or types of imaging devices.

In step S714, information that has been set by the user for adjusting image quality (hereinafter referred to as user-defined information) is read. The user-defined information includes, for example, sharpness, contrast, color matrix, tone curve, brightness, color saturation, hue, and white balance.

In step S715, white balance is adjusted based on user-defined information and/or general property information. General property information used for adjusting white balance includes, for example, information regarding light-source, whether flash is on or off, and flash intensity.

In step S716, red, green, and blue (RGB) color signals are converted into brightness (Y), reddishness (Cr), and bluishness (Cb) (YCrCb) signals. Then, in step S717, brightness is adjusted based on user-defined information and/or general property information. General property information used for adjusting brightness includes, for example, exposure time, shutter speed, aperture value, brightness value, exposure compensation factor, target distance, photometry, F number, and exposure program. Furthermore, in step S718, color is adjusted based on user-defined information and/or general property information.

In step S719, sharpness is adjusted based on user-defined information and/or general property information. General property information used for adjusting sharpness includes, for example, exposure time, shutter speed, aperture value, brightness value, exposure compensation factor, target distance, photometry, F number, exposure program, lens distortion, focal distance of the lens, minimum F value of the lens, and ISO speed rate.

In step S720, brightness, reddishness, and bluishness (YCrCb) signals are converted into red, green, and blue (RGB) color signals.

In step S721, the signals are converted into a common format and then saved. The common format is, for example, bitmap or JPEG format.

Since variation due to manufacturers and device types can be absorbed by the processing in steps S703 to S713 in this embodiment, image processing in steps S714 to S721 can be applied to any RAW image. Thus, when a favorable algorithm has been developed, it suffices to simply change the processing in steps S714 to S721 or add processing.

Furthermore, when CCD color filters having novel characteristics have become available, for the purpose of conversion into red, green, and blue (RGB) color signals for allowing common image processing in this embodiment, it suffices to add processing or modify the processing in steps S706 to S713. Furthermore, when new characteristic information that cannot be processed is included, or in the case of a RAW image file that cannot be read, information that cannot be processed is additionally written in a header of the RAW image file so that the information can be dealt with later by added or modified processing. That is, a RAW image file may be partially processed, handing the remaining part later by additional processing, or an unprocessed RAW image file that cannot be read may be handled by modified processing. Accordingly, maximum image processing is allowed, allowing image files in new formats to be processed using updates such as added or modified processing.

Although the property information in this embodiment has been described as recorded in a header attached to an image file, the property information may be recorded in a separate file or saved in a different media as long as the property information is saved in association with image information and can be read by an image processing apparatus.

As described hereinabove, according to the embodiment, in an image processing apparatus for reading and playing back image information that has been input from an image sensor and recorded without undergoing image processing, even when property information needed for image processing and/or playback of RAW image data and/or characteristics of main part of image information differs, common image processing can be used for image processing and/or playback. Thus, the user is freed of the concern for the difference relating to image processing, so that the ease of operation is improved. Furthermore, according to the embodiment, an original RAW image is converted into image data in a common format without reliance upon hardware characteristics in a substantially lossless manner by formalizing this way, that is, without losing the information of the original RAW image, image quality is substantially maintained. Furthermore, in developing image processing software, with regard to difference in RAW images, it suffices to modify source code for image processing only at particular parts, such as code relating to interfaces for inputting RAW images in different formats. This serves to reduce development cost.

Other Embodiments

It is to be understood that the objects of the present invention can be achieved by providing a system or apparatus with a storage medium having recorded thereon program code of software for achieving the functions of the embodiment described above, allowing a computer of the system or apparatus to read and execute the program code stored in the storage medium.

In this case, the program code read from the storage medium itself achieves the functions of the embodiment described above, so that the storage medium storing the program code constitutes the present invention.

The storage medium for storing the program code may be, for example, a flexible disk, a hard disk, an optical disk, a magneto-optical disk, a CD-ROM, a CD-R, a magnetic tape, a non-volatile memory card, or a ROM.

Also, it is to be understood that, as well as the case where the functions of the embodiment described above is achieved by the computer reading and executing the program code, it also falls with in the scope of the present invention when an OS (operating system) or the like running on the computer executes part of or the entire processing based on instructions of the program code, whereby the functions of the embodiment described above is achieved.

Furthermore, the program code read from the storage medium may be written in a memory of a functional extension board inserted in a computer or a functional extension unit connected to a computer so that a CPU or the like of the functional extension board or functional extension unit executes actual processing in part or in entirety based on instructions of the program code, whereby the functions of the embodiment described above are achieved. It is to be understood that this also falls within the scopes of the present invention.

Although the embodiment has been described in the context of an example where the imaging device is a CCD, other types of imaging device such as a CMOS imaging device may be used.

Although image data obtained by A/D conversion of signals output from an imaging device, without compressing it, is used as RAW image data in the embodiment, image data that has been lossless-compressed after A/D conversion may be used. Alternatively, RAW data may be analog signals output from an imaging device. Other types of RAW data may also be used, for example, A/D-converted image signals before adjustment of white balance, A/D-converted image signals before color separation into luminance signals and color signals, or signals output through color filters such as Beyar color filters before executing color interpolation.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing method for generating image data in a second format from image data in a first format, the image data in the first format including image data that is uncompressed or compressed and substantially losslessly, obtained by digitizing signals output from an imaging device, and the image data in the second format including a luminance signal and color signals, the image processing method comprising the steps of:
selecting a processing module to be used from among a plurality of types of processing modules, based on image property information associated with the image data in the first format;
converting the image data in the first format into image data in a third format that is different from the second format, using the processing module selected in the selecting; and
generating the image data in the second format based on the image data in the third format.

2. An image processing method according to claim 1, wherein in selecting, selection of a processing module for matching a bit depth of the image data in the first format with a predetermined bit depth, based on the image property information, is included.

3. An image processing method according to claim 1, wherein in selecting, based on the image property information, a processing module for converting the image data in the first format into a predetermined format, according to whether color filters of the imaging device that has output the image data in the first format are primary color filters or complementary color filters is selected.

4. An image processing method according to claim 1, wherein in selecting, based on the image property information, a processing module for converting the image data in the first format so that the image data has a predetermined aspect ratio in accordance with an aspect ratio of pixels of the imaging device that has output the image data in the first format is selected.

5. An image processing method according to claim 1, wherein in selecting, based on the image property information, a processing module for converting the image data in the first format into a predetermined format, in accordance with an arrangement of color filters of the imaging device that has output the image data in the first format is selected.

6. An image processing method according to claim 1, wherein in converting, based on the image property information, converting a unit of a parameter of property information associated with the image data in the first format into a predetermined unit is included.

7. An image processing method according to claim 1, wherein in selecting, based on the image property information, an expanding module for expanding the image data in the first format is selected.

8. An image processing method according to claim 1, wherein the image data in the third format is image data that does not depend on hardware characteristics of the imaging device.

9. An image processing apparatus for generating image data in a second format from image data in a first format, the image data in the first format including image data that is uncompressed or compressed and substantially losslessly, obtained by digitizing signals output from an imaging device, and the image data in the second format including a luminance signal and color signals, the image processing apparatus comprising:
a selecting unit which selects a processing module to be used from among a plurality of types of processing modules, based on image property information associated with the image data in the first format;
a converting unit which converts the image data in the first format into image data in a third format that is different from the second format, using the processing module selected by said selecting unit; and
a generating unit which generates the image data in the second format based on the image data in the third format.

10. A storage medium storing a control program for allowing a computer to execute image processing for generating image data in a second format from image data in a first format, the image data in the first format including image data that is uncompressed or compressed substantially losslessly, obtained by digitizing signals output from an imaging device, and the image data in the second format including a luminance signal and color signals, said control program comprising:
code for a selecting step, of selecting a processing module to be used from among a plurality of types of processing modules, based on image property information associated with the image data in the first format;
code for a converting step, of converting the image data in the first format into image data in a third format that is different from the second format, using the processing module selected in said selecting step; and
code for a generating step, of generating the image data in the second format based on the image data in the third format.

11. A control program for allowing a computer to execute image processing for generating image data in a second format from image data in a first format, the image data in the first format including image data that is uncompressed or compressed substantially losslessly, obtained by digitizing signals output from an imaging device, and the image data in the second format including a luminance signal and color signals, said control program comprising:
code for a selecting step, of selecting a processing module to be used from among a plurality of types of processing modules, based on image property information associated with the image data in the first format;
code for a converting step, of converting the image data in the first format into image data in a third format that is different from the second format, using the processing module selected in said selecting step; and
code for a generating step, of generating the image data in the second format based on the image data in the third format.
